(19) United States
(12) Patent Application Publication
(10) Pub. No.: US 2004/0120698 A1
(43) Pub. Date: Jun. 24, 2004

(54) System and method of transferring DV metadata to DVD-video data

(75) Inventor: Kurt M. Hunter, Sammamish, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/325,099

(22) Filed: Dec. 20, 2002

(51) Int. Cl. H04N 5/781

(52) U.S. Cl. 386/124; 386/125

(57) ABSTRACT

A method and system for converting DV (digital video) data having DV video frames and audio samples and having DV metadata into DVD-Video data. DV video frames and audio samples of streaming DV data is converted into corresponding DVD-Video video frames and audio samples and stored as DVD-Video data on a DVD recordable medium. The DV metadata of the streaming DV data is captured and stored as DVD-Video stream and Text Data (TXTDT) data of the DVD-Video data on the DVD recordable medium.

### TECHNICAL FIELD

The present invention relates to the field of converting DV (digital video) data into DVD-Video data. In particular, this invention relates to a method and system for preserving metadata of DV data when transferring DV data into DVD-Video data.

### BACKGROUND OF THE INVENTION

DV data is composed of streams of digital data: video (1), audio (1), and metadata (1 stream with many subcode packs of data: timecode, rec date, rec time, camera settings, etc.). DVD-Video data is composed of streams of digital data: video (1), audio (0-8), subpictures (0-32), presentation data (1), and navigation data (1) along with other forms of data including navigation menus, still pictures, seamless branching information, parental management, Text Data (TXTDT), jacket pictures, etc. When video data is converted from one form to another form, metadata regarding the video data may be partially or totally lost. In particular, when DV data is converted to DVD-Video data, the metadata associated and stored with the DV data is lost. DV metadata is data about the DV data itself, such as the time of creation of the DV data, date of creation, parameters of creation (aperture size, various other camera settings), or any other environmental aspects relating to the DV data. At least in some cases, loss of this data is undesirable, particularly for an author of the DV data who would like to preserve all relevant metadata associated with the DV data which has been created. As a specific example, a consumer who makes a DV recording using a camera (such as a camcorder) may want to convert the DV recording into a DVD-Video formatted data set and may want to preserve the metadata associated with the DV recording as part of the DVD-Video data set. The DVD-Video data set maybe be written to a recordable DVD media or manufactured into DVD-Video discs for use in DVD-Video playback devices. Preservation of this data will ensure the consumer that the DVD-Video converted from the DV recording is a complete archive of all information relating to the DV recording.

For these reasons, a system and method for preserving DV metadata when copying DV data to DVD-Video data is desired to address one or more of these and other disadvantages.

### SUMMARY OF THE INVENTION

The invention includes a system and method of converting DV digital video data having DV video frames and audio samples and having DV metadata into DVD-Video data. The invention also includes a computer readable medium having computer executable instructions for converting streaming DV digital video data having DV video frames and audio samples and having DV metadata into DVD-Video data. The invention also includes a DVD recordable computer readable medium having stored thereon a data structure corresponding to DV digital video metadata of DV data including DV video frames and audio samples. In one form, this invention is about decoding subcode packs from the DV metadata stream and storing the decoded data on DVD-Video in subpicture streams and the Text Data structure in a specific way.

One advantage of the invention is that it allows an author of a DV recording to preserve the metadata relating to the recording when the recording is converted to DVD-Video. The invention permits the metadata to be read or accessed from the corresponding DVD-Video so that the author can determine such parameters as time of recording, date of recording and/or camera setting employed during recording.

In one form, the invention comprises a method of converting DV digital video data having DV video frames and audio samples and having DV metadata into DVD-Video data, the method comprising:

streaming the DV data, from the acquisition device;

converting the DV video frames and audio samples of the DV data into corresponding DVD-Video video frames and audio samples;

capturing the DV metadata of the streaming DV data;

storing the converted DVD-Video frames as DVD-Video data; and

storing the captured DV metadata as DVD-Video stream data in a DVD-Video stream of the DVD-Video data.

In another form, the invention is a system for converting DV data having DV video frames and audio samples and having DV metadata into DVD-Video data, the system comprises a memory; a DVD recordable drive for recording on a DVD recordable medium; a processor accessing the memory and controlling the DVD recordable drive; a network interface responsive to the processor for streaming the DV data; a publisher and a converter. The publisher is stored in the memory and is executed by the processor for converting the DV video frames and audio samples of the DV data into corresponding DVD-Video video frames and audio samples and for storing via the DVD recordable drive the converted DVD-Video video frames and audio samples as DVD-Video data on the DVD recordable medium, the converter is stored in the memory and is executed by the processor for capturing the DV metadata of the streaming DV data and for storing via the DVD recordable drive the captured DV metadata as DVD-Video stream data in a DVD-Video streams of the DVD-Video data on the DVD recordable medium.

In another form, the invention is a method of converting DV digital video data having DV video frames and audio samples and having DV metadata into DVD-Video data, the method comprising:

converting the DV video frames and audio samples of the DV data into corresponding DVD-Video video frames and audio samples;

capturing the DV metadata of the DV data;

storing the converted DVD-Video video frames and audio samples as DVD-Video data; and

storing the captured DV metadata as DVD-Video stream data in a DVD-Video stream of the DVD-Video data.

In another form, the invention is a system for converting DV digital video data having DV video frames and audio samples and having DV metadata into DVD-Video data. The system comprises a memory; a DVD recordable drive for recording on a DVD recordable medium; a processor accessing the memory and controlling the DVD recordable drive; a publisher; and a converter. The publisher is stored in the memory and is executed by the processor for converting the DV video frames and audio samples of the DV data into corresponding DVD-Video video frames and audio samples and for storing via the DVD recordable drive the converted DVD-Video video frames and audio samples as DVD-Video data on the DVD recordable medium. The converter is stored in the memory and is executed by the processor for capturing the DV metadata of the DV data and for storing via the DVD recordable drive the captured DV metadata as DVD-Video stream data in a DVD-Video stream of the DVD-Video data on the DVD recordable medium.

In another form, the invention is a computer readable medium having computer executable instructions for converting streaming DV digital video data having DV video frames and audio samples and having DV metadata into DVD-Video data. The instructions include:

converting the DV video frames and audio samples of the streaming DV data into corresponding DVD-Video video frames and audio samples;

capturing the DV metadata of the streaming DV data;

providing the captured DV metadata as DVD-Video stream data for storage in a DVD-Video stream of the DVD-Video data.

In another form the invention is a DVD recordable computer readable medium having stored thereon a data structure corresponding to DV digital video metadata of DV data including DV video frames and audio samples. The data structure comprises DVD-Video data including DVD-Video frames corresponding to the DV video frames and audio samples and DVD-Video stream data corresponding to the DV metadata in a DVD-Video stream.

In another form, the invention is a method of converting captured DV data including a video portion, an audio portion and a metadata portion into DVD-Video data, the method comprising:

converting the video portion and the audio portion of DV data into corresponding DVD-Video video data and DVD-Video audio data; and

converting parts of the metadata portion of DV data into DVD-Video sub-picture streams and DVD-Video Text Data (TXTDT).

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of an exemplary embodiment of a method of converting DV data into DVD-Video data according to one preferred embodiment of the invention.

FIG. 2 is an exemplary block diagram according to one preferred embodiment of the invention illustrating a system for converting DV data from a DV video device into DVD-Video data recorded on DVD recordable medium.

FIG. 3 is an exemplary flow chart according to one preferred embodiment of the invention illustrating operation of the system of FIG. 2 and illustrating a method according to the invention for converting DV data into DVD-Video data.

FIGS. 4 and 5 are screen shots of English (United States) and Russian regional and language options for the Windows operating system which may be used in conjunction with one preferred embodiment of the invention for converting DV data into DVD-Video data.

FIG. 6 is a block diagram illustrating an exemplary computer-readable medium (CRM) on which DVD-Video data converted from DV data including DV video frames and audio samples and DV metadata is stored according to the invention.

FIG. 7 is a block diagram illustrating one example of a suitable computing system environment in which the invention may be implemented.

Corresponding reference characters indicate corresponding parts throughout the drawings.

### DETAILED DESCRIPTION OF THE INVENTION

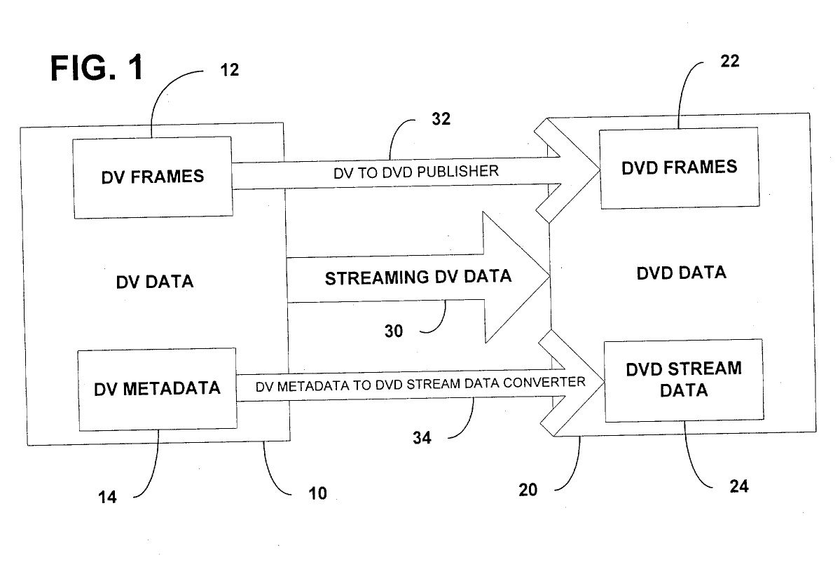

Referring first to FIG. 1, a block diagram of an exemplary embodiment of a method for converting DV data into DVD-Video data according to one preferred embodiment of the invention is illustrated. Reference character 10 refers to DV data which is to be converted into DVD-Video data 20. The DV data 10 includes DV video frames and audio samples 12 which are digital information defining frames of video and samples of audio and DV metadata 14 which is digital information relating to the DV data in general. As DV data 10 including audio, video, and metadata is copied from DV tape to the computer's hard disc and then converted or converted on-the-fly or otherwise collected, it is converted into DVD-Video data 20 which includes DVD-Video video frames and audio samples 22 and includes a plurality of sub-picture streams having data therein and herein referred to as DVD-Video stream data 24. Arrow 30 illustrates the streaming DV data which is to be converted into DVD-Video data. According to the invention, the conversion has two aspects. In a first aspect, a DV to DVD-Video publisher indicated by arrow 32 converts the DV video frames and audio samples 12 into the DVD-Video frames 22. As a second aspect, a DV metadata to DVD-Video stream data converter as indicated by an arrow 34 converts the DV metadata 14 into DVD-Video stream data 24.

In general, it is contemplated that the DV to DVD-Video publisher 32 would work independently of the converter 34. Thus, any publisher 32 which converts DV video frames and audio samples to DVD-Video frames may be employed. Independent thereof, the converter 34 captures the DV metadata 14 of the streaming DV data 30 and stores the captured DV metadata as DVD-Video stream data (e.g., text) in a DVD-Video stream of the DVD-Video data 20.

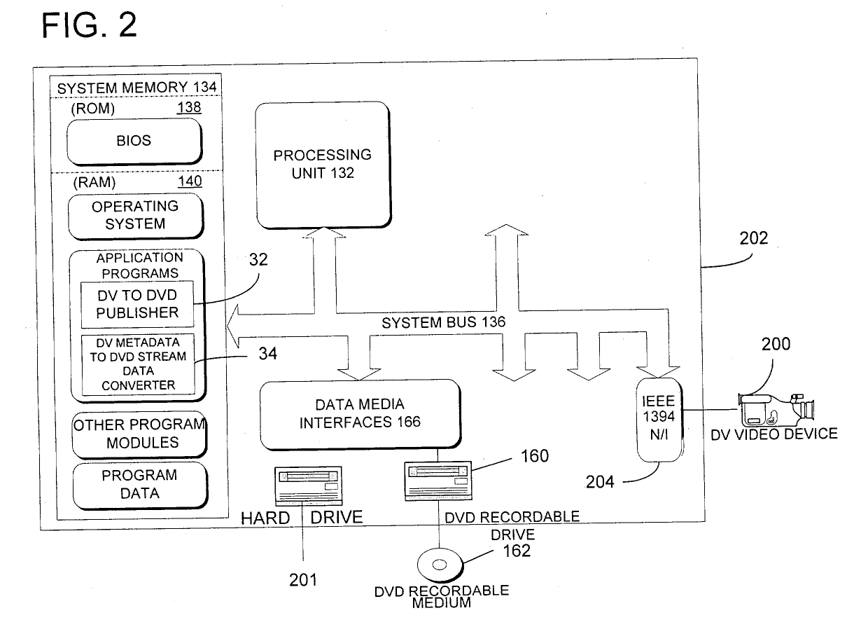

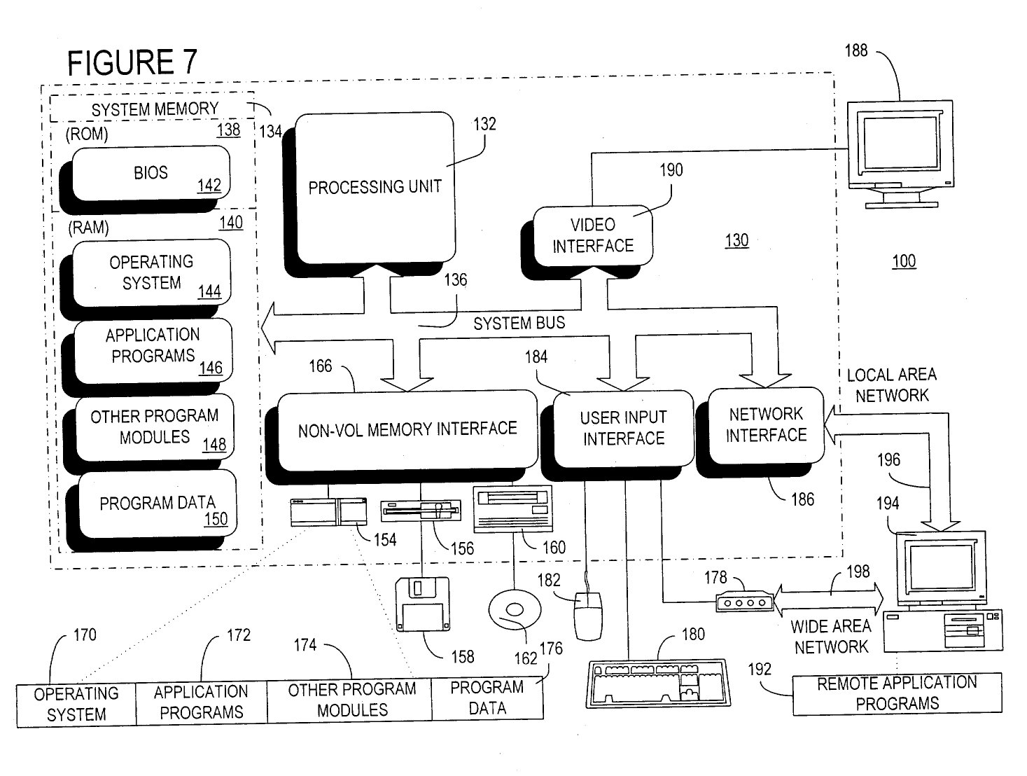

Referring to FIG. 2, an exemplary block diagram according to one preferred embodiment of the invention is illustrated showing a system for converting DV data from a DV video device such as a camcorder 200 or from a hard disk 201 having formatted DVD-Video data into DVD-Video data recorded on a non-volatile optical disk such as a DVD-Video recordable medium 162. Although the invention has been described in the context of converting streaming DV data, it is contemplated that the invention is applicable to converting DV data in any form or format. For example, the computer system that captures and converts the DV data into DVD-Video data does not necessarily need to have a DVD recordable drive. The DVD-Video data can be stored on a computer hard disc and played back using DVD-Video playback software and/or transferred to digital tape (or other digital media) for mastering for DVD-Video manufactured discs or written to recordable DVD media. In addition, it is also contemplated that the source of the DV data may be a medium on which the DV data is stored or a source of streaming DV data other than a camcorder 200. FIG. 2 is intended to provide an overview of the system. A more detailed description of the system is illustrated in FIG. 7 and provided below.

Reference character 202 refers to a block which is intended to represent a personal computer. A system bus 136 interconnects the various elements of computer 202. Various network interfaces may be part of the computer 202 including an IEEE 1394 network interface 204 for receiving the DV data from camcorder 200. The bus 136 communicates with a processing unit 132 which accesses a system memory 134 and which controls one or more optical disk drives which are part of the computer 202 and accessed via a data media interface 166. In particular, the computer 202 may include a DVD-Video recordable drive 160 for recording the DVD-Video data onto a DVD-Video recordable medium 162. Thus, interface 166 is a non-volatile memory interface between the processing unit 132 and the drive 160.

The system memory 134 includes a read-only memory (ROM) 138 including a BIOS and a random access memory (RAM) 140 including an operating system, application programs, other program modules and program data. As part of the application programs, the DV to DVD-Video publisher 32 is included and the DV metadata to DVD-Video stream data converter 34 is included. The publisher 32 is stored in the system memory 134 and executed by the processing unit 132 for converting the DV video frames and audio samples of the DV data into corresponding DVD-Video frames and for storing via the DVD-Video recordable drive 160 the converted DVD-Video frames as DVD-Video data on the DVD-Video recordable medium 162. The converter 34 is also stored in the system memory 134 and executed by the processing unit 132 for capturing the DV metadata of the DV data and for storing via the DVD-Video recordable drive 160 the captured DV metadata as DVD-Video stream data in a DVD-Video stream of the DVD-Video data on the DVD-Video recordable medium 162.

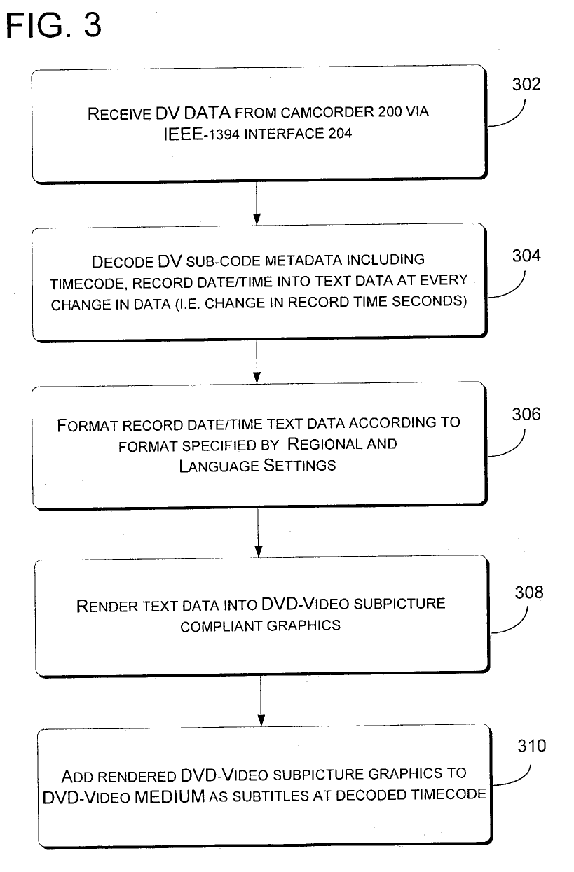

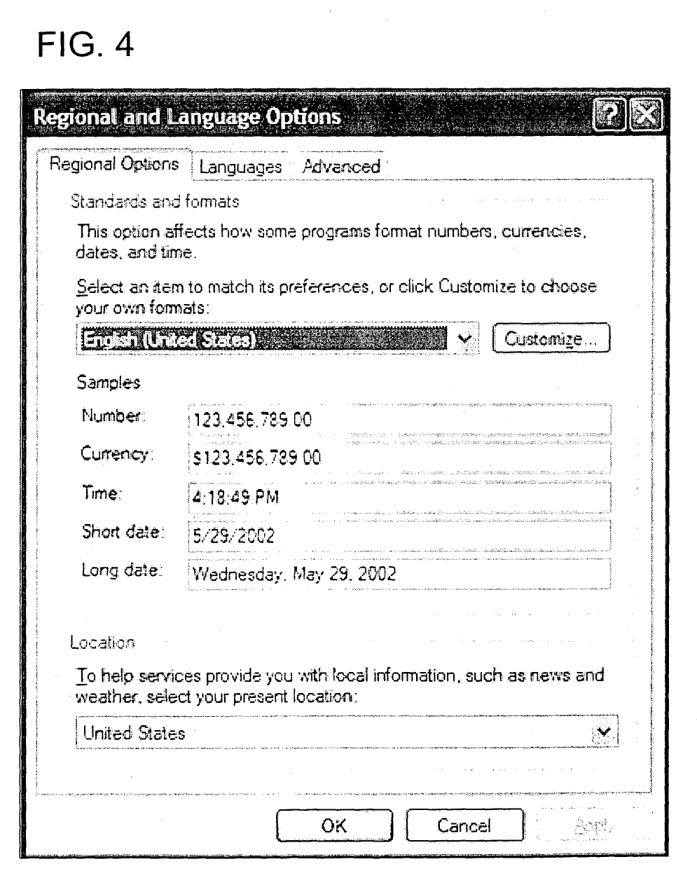

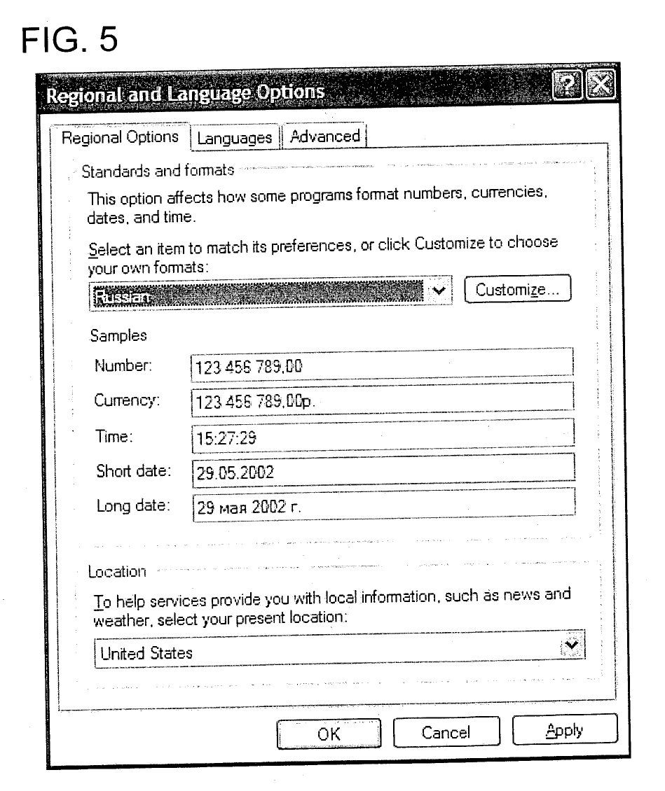

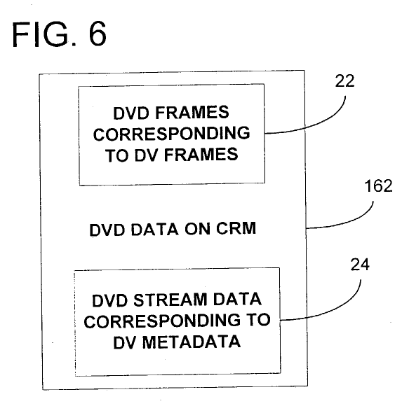

Referring to FIG. 3, an exemplary flow chart according to one preferred embodiment of the invention is illustrated showing the operation of the system of FIG. 2 and showing a method according to the invention for converting DV data into DVD-Video data. At 302, the computer 202 receives the DV data from camcorder 200 via the IEEE 1394 interface 204. At 304, the processing unit 132 executes converter 34 to decode the DV subcode metadata including time code, record time/date, etc. into text data at every change in data (i.e., at every change in record time seconds). Next, at 306, the processing unit 132 continues to execute converter 34 to format the record date/time text data according to the format specified in the regional and language settings of the computer 202. In particular, FIGS. 4 and 5 illustrate screen shots of regional and language options for an English (United States) computer and a Russian computer. The converter 34 takes these settings into account in generating the text data which will be stored in the streams of the DVD-Video recordable medium 162. Referring back to FIG. 3, at 308, the converter 34 renders the text data into DVD-Video sub-picture compliant graphics which may be stored in a stream of the DVD-Video recordable medium 162. Finally at 310, the rendered DVD-Video sub-picture graphics are added to the DVD-Video medium 162 as subtitles at the coded time code. Thus, FIG. 6 illustrates the data structure of DVD-Video recordable medium 162 in that it includes DVD-Video data on a computer readable medium which may be a CD-ROM or other medium. It includes DVD-Video frames 22 corresponding to the DV video frames and audio samples 12 and it also includes DVD-Video stream data 24 corresponding to the DV metadata 14.

### EXAMPLE

Every DV video frame encoded in the DV format contains a number of“sub-code” metadata “packs.” Each sub-code pack is a set of five (5) bytes of data including a one (1) byte header. Details of these packs can be found in the international standard IEC 61834-4 Recording—Helical-scan digital video cassette recording system using 6.35 mm magnetic tape for consumer use (525-60, 625-50, 1125-60 and 1250-50 systems)—Part 4: Pack header table and contents.

Of primary interest are the TTC “Title Time Code” pack (pack header=13 h), VRD “VAUX Record Date” pack (pack header=62 h), and VRT “VAUX Record Time” pack (pack header=63 h). Of secondary interest, due to the fact that they are optional packs and may not be recorded by every DV video device manufacturer, are the “Consumer Camera 1” pack (pack header=70 h) and the “Consumer Camera 2” pack (pack header=71 h).

The TTC pack contains the SMPTE/EBU timecode which indicates the elapsed time of the tape and acts as an index to the associated video frames and other sub-code packs.

The VRD pack contains the date when the video data was recorded. This includes a daylight savings time indicator, a time zone indicator including a 30-minute offset flag, the day of the week, and the month, day, and year of the recording.

The VRT pack contains the time when the video data was recorded. This includes the hour, minutes, and seconds in 24 hour time.

The Consumer Camera 1 pack contains the iris setting (f-stop), exposure mode, gain control value, white balance mode and setting, focus mode, and the focus distance.

The Consumer Camera 2 pack contains the image stabilizer status, vertical and horizontal panning speed(s), focal length, and the zoom settings.

A first operation phase of the invention is to extract the relevant sub-code packs from the DV data stream and decode the binary data into textual data. To minimize the redundant data, only changes in data other than timecode are preserved. For example, a change in record date or a second change of time would be recorded.

The following Table 1A illustrates a phase one example. Table 1A presents an example of the five (5) bytes of data in a TTC pack.

TABLE 1A
TTC pack

| | | | | | | | | |
|---|---|---|---|---|---|---|---|---|
| PC 0 | 0 | 0 | 0 | 1 | 0 | 0 | 1 | 1 |
| PC 1 | 0 | 1 | 0 | 0 | 0 | 0 | 1 | 0 |
| PC 2 | 1 | 0 | 0 | 0 | 0 | 0 | 0 | 0 |
| PC 3 | 1 | 0 | 0 | 0 | 0 | 0 | 0 | 0 |
| PC 4 | 1 | 1 | 0 | 0 | 0 | 0 | 0 | 0 |

The data in Table 1A decodes into the following timecode: “00:00:00:02”, zero hours, zero minutes, zero seconds, two frames.

Table 1B illustrates the decoding process. Each subscripted value in Table 1B is decoded into a corresponding subscripted value in decoded time code.

TTC pack

Column No.:

| | 1 | 2 | 3 | 4 | 5 | 6 | 7 | 8 |
|---|---|---|---|---|---|---|---|---|
| PC 0 | 0 | 0 | 0 | 1 | 0 | 0 | 1 | 1 |
| PC 1 | 0 | 1 | 0₇ | 0₇ | 0₈ | 0₈ | 1₈ | 0₈ |
| PC 2 | 1 | 0₅ | 0₅ | 0₅ | 0₆ | 0₆ | 0₆ | 0₆ |
| PC 3 | 1 | 0₃ | 0₃ | 0₃ | 0₄ | 0₄ | 0₄ | 0₄ |
| PC 4 | 1 | 1 | 0₁ | 0₁ | 0₂ | 0₂ | 0₂ | 0₂ |

The data in Table 1B decodes into the following timecode: “0₁0₂:0₃0₄:0₅0₆:0₇2₈”. For example, the bits in column 3 and 4 of row PC 4 decode into zero tens of hours of elapsed time (the first digit of the timecode). As another example, the bits of columns 5-8 of row PC 1 decode into 2 elapsed frames (the last digit of the timecode).

The following Table 2A illustrates another phase one example. Table 2A presents an example of the five (5) bytes of data in a VRD pack.

TABLE 2A
VRD pack

| | | | | | | | | |
|---|---|---|---|---|---|---|---|---|
| PC 0 | 0 | 1 | 1 | 0 | 0 | 0 | 1 | 0 |
| PC 1 | 0 | 1 | 0 | 1 | 0 | 1 | 1 | 0 |
| PC 2 | 1 | 1 | 1 | 1 | 0 | 0 | 0 | 0 |
| PC 3 | 0 | 0 | 0 | 0 | 0 | 1 | 1 | 1 |
| PC 4 | 0 | 0 | 0 | 0 | 0 | 0 | 0 | 0 |

The data in Table 2A decodes into the following record date: “07/30/2000”, the month of July (7), the 30^{th} day of that month, in the year of 2000.

Table 2B illustrates the decoding process. Each subscripted value in Table 2B is decoded into a corresponding subscripted value in decoded record date.

TABLE 2B
VRD pack

Column No.:

| | 1 | 2 | 3 | 4 | 5 | 6 | 7 | 8 |
|---|---|---|---|---|---|---|---|---|
| PC 0 | 0 | 1 | 1 | 0 | 0 | 0 | 1 | 0 |
| PC 1 | 0 | 1 | 0 | 1 | 0 | 1 | 1 | 0 |
| PC 2 | 1 | 1 | 1₃ | 1₃ | 0₄ | 0₄ | 0₄ | 0₄ |
| PC 3 | 0 | 0 | 0 | 0₁ | 0₂ | 1₂ | 1₂ | 1₂ |
| PC 4 | 0₅ | 0₅ | 0₅ | 0₅ | 0₆ | 0₆ | 0₆ | 0₆ |

The data in Table 2B decodes into the following record date: “0₁7₂/3₃0₄/200₅06”. For example, the bits in column 3 and 4 of row PC 2 decode into 3 tens of days (the third digit of the record date). As another example, the bits of columns 5-8 of row PC 4 decode into zero (0) years (the last digit of the record date).

The following Table 3A illustrates another phase one example. Table 3A presents an example of the five (5) bytes of data in a VRT pack.

TABLE 3A
VRT pack

| | | | | | | | | |
|---|---|---|---|---|---|---|---|---|
| PC 0 | 0 | 1 | 1 | 0 | 0 | 0 | 1 | 1 |
| PC 1 | 1 | 1 | 0 | 0 | 0 | 0 | 1 | 0 |
| PC 2 | 1 | 0 | 0 | 0 | 0 | 1 | 1 | 1 |
| PC 3 | 1 | 0 | 0 | 0 | 1 | 0 | 0 | 0 |
| PC 4 | 1 | 1 | 0 | 1 | 0 | 0 | 0 | 1 |

The data in Table 3A decodes into the following record time: “11:08:07”, eight minutes and seven seconds past eleven A. M.

Table 3B illustrates the decoding process. Each subscripted value in Table 3B is decoded into a corresponding subscripted value in decoded record time.

TABLE 3B
VRT pack

Column No.:

| | 1 | 2 | 3 | 4 | 5 | 6 | 7 | 8 |
|---|---|---|---|---|---|---|---|---|
| PC 0 | 0 | 1 | 1 | 0 | 0 | 0 | 1 | 1 |
| PC 1 | 1 | 1 | 0 | 0 | 0 | 0 | 1 | 0 |
| PC 2 | 1 | 0₅ | 0₅ | 0₅ | 0₆ | 1₆ | 1₆ | 1₆ |
| PC 3 | 1 | 0₃ | 0₃ | 0₃ | 1₄ | 0₄ | 0₄ | 0₄ |
| PC 4 | 1 | 1 | 0₁ | 1₁ | 0₂ | 0₂ | 0₂ | 1₂ |

The data in Table 3B decodes into the following record time: “1₁1₂:0₃8₄:0₅7₆”. For example, the bits in column 5-8 of row PC 3 decode into 8 minutes (the fourth digit of the record date). As another example, the bits of columns 2-4 of row PC 2 decode into zero (0) tens of seconds (the next to last digit of the record time).

Therefore, a table of timecode, record date and record time can be collected with an entry for every change in the record time seconds of the DV data as shown in Table 4:

TABLE 4

| | | Rec |
|---|---|---|
| Timecode | Rec Date | Time |
| 00:00:00:02 | Jul. 30, 2000 | 11:08:07 |
| 00:00:00:14 | Jul. 30, 2000 | 11:08:08 |
| 00:00:01:14 | Jul. 30, 2000 | 11:08:09 |
| 00:00:02:14 | Jul. 30, 2000 | 11:08:10 |
| 00:00:03:14 | Jul. 30, 2000 | 11:08:11 |
| 00:00:04:13 | Jul. 30, 2000 | 11:08:12 |
| 00:00:05:13 | Jul. 30, 2000 | 11:08:13 |
| 00:00:06:13 | Jul. 30, 2000 | 11:08:14 |
| 00:00:07:13 | Jul. 30, 2000 | 11:08:15 |
| 00:00:08:13 | Jul. 30, 2000 | 11:08:16 |
| . . . | | |

With respect to the record date and time, a second operation phase of the invention is to format the date and time according to the user's current regional and language settings (see FIGS. 4 and 5). The regional and language settings define the textual formatting of date and time strings.

A third operation phase of the invention is the rendering of the formatted text data into DVD-Video compliant sub-picture graphics. DVD-Video sub-picture graphics are composed of 4 colors from a palette of 16 colors. Each pixel is designated as foreground, background, emphasis-1, or emphasis-2 and can have one of 16 levels of transparency. The regional and language settings are taken into account to determine the placement and direction of the rendered text data. For example, English (United States) is left to right in the lower left hand corner of the display and Hebrew is right to left in the lower right hand corner.

A fourth operation phase of the invention is to pass the sub-picture graphics along with the “normalized” timecode (i.e., from phase one) to the DVD-Video mastering engine (e.g., publisher 32) which handles the proper formatting for DVD-Video creation. The normalized timecode is the SMPTE/EBU timecode from the DV sub-code pack adjusted to the actual frame sequence of the MPEG-2 encoded DV video data.

Since the DV metadata is encoded as DVD-Video sub-pictures, the end user can control the display of this data as an overlay on the video via the DVD-Video device remote control. Additionally, the display can be controlled by the DVD-Video content programmatic control with effects such as fade, wipe, and crawl.

### EXAMPLE

The following is an example of one implementation, wherein DVD Text Data (TXTDT) is used to store the relevant textual DV metadata for authored DVD-Video discs, along with other DVD-Video authoring metadata.

Referring to Annex A, “Definition of IT_TXT_IDCD and description rule of IT_TXT_SRP and Definition of Termination code” of the DVD-Video specification:

Textual metadata referring to the entire disc shall use the structure IDCD of “Volume” (0×01). Textual metadata referring to a specific title shall use the structure IDCD of “Title” (0×02). Textual metadata referring to a specific chapter shall use the structure IDCD of “Part_of_Title (PTT)” (0×04). Textual metadata referring to a specific clip within a chapter shall use the structure IDCD of“Cell” (0×05).

Specific mapping of textual metadata into DVD-Video Text Data (TXTDT) format shall be:

| DVD-Video Structure | Metadata Stored |
|---|---|
| Volume (0 × 01) | |
| General/name (0 × 30) | Disc Title (e.g. “The Attack of Goo”) |
| General/comments (0 × 31) | User Notes (e.g. “Hi Grandma, this . . . ”) |
| Character/producer (0 × 71) | Author's name |
| Add. Admin./release date | Date/time of disc creation |
| (0 × B8) | |
| Add. Admin./authoring info | DVD authoring app name with version |
| (0 × C7) | |
| Add. Admin./other info | OS Name with version |
| (0 × C9) | |
| Title (0 × 02) | |
| General/name (0 × 30) | Title name |
| Other name/label (0 × 53) | Title number |
| PTT (0 × 04) | |
| General/name (0 × 30) | Chapter name |
| Other name/label (0 × 53) | Chapter number |
| Add. Admin./org. release date | Rec date/time of first frame of chapter |
| (0 × BD) | |
| Cell (0 × 05) | |
| Add. Admin/recording info | Iris, AE mode, AGC, WB mode, white |
| (0 × C4) | balance, FCM, Focus, VPD, V panning |
| | speed, HPD, H panning speed, IS, Focal |
| | length, ZEN, E-zoom, Shutter speed |
| | (refer to Consumer Camera packs 1 and |
| | 2 and Shutter pack of the DV |
| | specification) from the first frame of the |
| | Cell. |

Portions of the DV metadata are used to populate the Part_of_Title/Additional administration/original release date items and the Cell/Additional administration/recording information items.

FIG. 7 shows one example of a general purpose computing device in the form of computer 202. Computer 202 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 202 typically has at least some form of computer readable media. Computer readable media, which include both volatile and nonvolatile media, removable and non-removable media, may be any available medium that can be accessed by computer 202. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, DVD-ROM 162 or other optical disk storage, magnetic cassettes, magnetic tape, magnetic disk storage or other magnetic storage devices, or any other medium that can be used to store the desired information and that can accessed by computer 202. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 202, such as during start-up, is typically stored in ROM 138. RAM 140 typically contains data and/or program modules that are immediately accessible to and/or presently being operated on by processing unit 132. By way of example, and not limitation, FIG. 7 illustrates operating system 144, application programs 146, other program modules 148, and program data 150.

The computer 202 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 144, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 202. In FIG. 7, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 202 through input devices or user interface selection devices such as a keyboard 180 and a pointing device 182 (e.g., a mouse, trackball, pen, or touch pad). Other input devices (not shown) may include a microphone, joystick, game pad, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 202 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 202. The logical connections depicted in FIG. 7 include a local area network (LAN) 196 and a wide area network (WAN) 198, but may also include other networks. Such networking environments are commonplace in offices, enterprise-wide computer networks, intranets, and global computer networks (e.g., the Internet).

When used in a local area networking environment, computer 202 is connected to the LAN 196 through a network interface or adapter 186. When used in a wide area networking environment, computer 202 typically includes a modem 178 or other means for establishing communications over the WAN 198, such as the Internet. The modem 178, which may be internal or external, is connected to system bus 136 via the user input interface 194, or other appropriate mechanism. In a networked environment, program modules depicted relative to computer 202, or portions thereof, may be stored in a remote memory storage device (not shown). By way of example, and not limitation, FIG. 7 illustrates remote application programs 192 as residing on the memory device. It will be appreciated that the network connections shown are exemplary and other means of establishing a communications link between the computers may be used.

Generally, the data processors of computer 202 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 202, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of converting DV digital video data having DV video frames and audio samples and having DV metadata into DVD-Video data, said method comprising:
streaming the DV data, from the acquisition device, typically a DV camcorder;
converting the DV video frames and audio samples of the DV data into corresponding DVD-Video video frames and audio samples;
capturing the DV metadata of the streaming DV data;
storing the converted DVD-Video frames as DVD-Video data; and
storing the captured DV metadata as DVD-Video stream data in a DVD-Video stream of the DVD-Video data.

2. The method of claim 1 wherein the DV metadata comprises sub-code packs of binary data and wherein the capturing comprises:
extracting the sub-code packs from the streaming DV data;
decoding the binary data in the extracted sub-code packs into textual data; and wherein storing the captured DV metadata comprises:
storing the textual data in the DVD-Video streams of the DVD-Video data.

3. The method of claim 2 wherein decoding comprises rendering the textual data into a DVD-Video sub-picture graphics.

4. The method of claim 3 wherein capturing is performed by a computer having regional and/or language settings and wherein capturing includes reformatting date and/or time information of the DV metadata according to the regional and/or language settings.

5. The method of claim 3 wherein capturing is performed by a computer having regional and/or language settings and wherein the rendering is in accordance with the regional and/or language settings.

6. The method of claim 2 wherein only changes in non-timecode binary data are stored as textual data.

7. The method of claim 1 wherein the storing comprising storing the captured DV metadata as a DVD-Video sub-picture graphics.

8. The method of claim 1 wherein capturing is performed by a computer having regional and/or language settings and wherein capturing includes reformatting the date and/or time information according to the regional and/or language settings.

9. The method of claim 1 wherein capturing is performed by a computer having regional and/or language settings and wherein the rendering is in accordance with the regional and/or language settings.

10. The method of claim 1 further comprising selecting the DVD-Video sub-picture streams in which the DV metadata is stored.

11. A system for converting DV data having DV video frames and audio samples and having DV metadata into DVD-Video data, said system comprising:
a memory;
a DVD recordable drive for recording on a DVD recordable medium;
a processor accessing the memory and controlling the DVD recordable drive;
a network interface responsive to the processor for streaming the DV data;
a publisher stored in the memory and executed by the processor for converting the DV video frames and audio samples of the DV data into corresponding DVD-Video video frames and audio samples and for storing via the DVD recordable drive the converted DVD-Video video frames and audio samples as DVD-Video data on the DVD recordable medium;
a converter stored in the memory and executed by the processor for capturing the DV metadata of the streaming DV data and for storing via the DVD recordable drive the captured DV metadata as DVD-Video stream data in a DVD-Video streams of the DVD-Video data on the DVD recordable medium.

12. The system of claim 11 wherein the DV metadata comprises sub-code packs of binary data and wherein the converter:
extracts the sub-code packs from the streaming DV data;
decodes the binary data in the extracted sub-code packs into textual data; and stores the textual data in the DVD-Video streams of the DVD-Video data on the DVD recordable medium.

13. The system of claim 12 wherein the converter renders the textual data into DVD-Video sub-picture graphics stored on the DVD recordable medium.

14. The system of claim 13 wherein the processor has regional and/or language settings and wherein the converter reformats date and/or time information of the DV metadata according to the regional and/or language settings.

15. The system of claim 13 wherein the processor has regional and/or language settings and wherein the converter renders the textual data in accordance with the regional and/or language settings.

16. The system of claim 12 wherein the converter stores only changes in non-timecode binary data as textual data on the DVD recordable medium.

17. The system of claim 11 wherein the converter stores the captured DV metadata as DVD-Video sub-picture graphics.

18. The system of claim 11 wherein the processor has regional and/or language settings and wherein converter reformats the date and/or time information according to the regional and/or language settings.

19. The system of claim 11 wherein the processor has regional and/or language settings and wherein the converter renders the textual data in accordance with the regional and/or language settings.

20. The system of claim 11 wherein the converter permits a user to select a particular DVD-Video sub-picture stream as the DVD-Video stream in which the DVD-Video data is stored on the DVD recordable medium.

21. A method of converting DV digital video data having DV video frames and audio samples and having DV metadata into DVD-Video data, said method comprising:
converting the DV video frames and audio samples of the DV data into corresponding DVD-Video video frames and audio samples;
capturing the DV metadata of the DV data;
storing the converted DVD-Video video frames and audio samples as DVD-Video data; and
storing the captured DV metadata as DVD-Video stream data in a DVD-Video stream of the DVD-Video data.

22. The method of claim 21 wherein the DV metadata comprises sub-code packs of binary data and wherein the capturing comprises:
extracting the sub-code packs from the DV data;
decoding the binary data in the extracted sub-code packs into textual data; and wherein storing the captured DV metadata comprises:
storing the textual data in the DVD-Video stream of the DVD-Video data.

23. The method of claim 22 wherein decoding comprises rendering the textual data into DVD-Video sub-picture graphics.

24. The method of claim 23 wherein capturing is performed by a computer having regional and/or language settings and wherein capturing includes reformatting date and/or time information of the DV metadata according to the regional and/or language settings.

25. The method of claim 23 wherein capturing is performed by a computer having regional and/or language settings and wherein the rendering is in accordance with the regional and/or language settings.

26. A system for converting DV digital video data having DV video frames and audio samples and having DV metadata into DVD-Video data, said system comprising:
a memory;
a DVD recordable drive for recording on a DVD recordable medium;
a processor accessing the memory and controlling the DVD recordable drive;
a publisher stored in the memory and executed by the processor for converting the DV video frames and audio samples of the DV data into corresponding DVD-Video video frames and audio samples and for storing via the DVD recordable drive the converted DVD-Video video frames and audio samples as DVD-Video data on the DVD recordable medium;
a converter stored in the memory and executed by the processor for capturing the DV metadata of the DV data and for storing via the DVD recordable drive the captured DV metadata as DVD-Video stream data in a DVD-Video stream of the DVD-Video data on the DVD recordable medium.

27. The system of claim 26 wherein the DV metadata comprises sub-code packs of binary data and wherein the converter:
extracts the sub-code packs from the DV data;
decodes the binary data in the extracted sub-code packs into textual data; and
stores the textual data in the DVD-Video stream of the DVD-Video data on the DVD recordable medium.

28. The system of claim 27 wherein the converter renders the textual data into DVD-Video sub-picture graphics stored on the DVD recordable medium.

29. The system of claim 28 wherein the processor has regional and/or language settings and wherein the converter reformats date and/or time information of the DV metadata according to the regional and/or language settings.

30. The system of claim 29 wherein the processor has regional and/or language settings and wherein the converter renders the textual data in accordance with the regional and/or language settings.

31. The system of claim 26 wherein the converter stores only changes in non-timecode binary data as textual data on the DVD recordable medium.

32. A computer readable medium having computer executable instructions for converting streaming DV digital video data having DV video frames and audio samples and having DV metadata into DVD-Video data, said instructions comprising:
converting the DV video frames and audio samples of the streaming DV data into corresponding DVD-Video video frames and audio samples;
capturing the DV metadata of the streaming DV data;
providing the captured DV metadata as DVD-Video stream data for storage in a DVD-Video stream of the DVD-Video data.

33. The medium of claim 32 wherein the DV metadata comprises sub-code packs of binary data and wherein the capturing comprises:
extracting the sub-code packs from the streaming DV data;
decoding the binary data in the extracted sub-code packs into textual data; and wherein providing the captured DV metadata comprises:
providing the textual data as DVD-Video stream data for storage in the DVD-Video track of the DVD-Video data.

34. The medium of claim 33 wherein decoding comprises rendering the textual data into DVD-Video sub-picture graphics.

35. The medium of claim 34 wherein capturing is performed by a computer having regional and/or language settings and wherein capturing includes reformatting date and/or time information of the DV metadata according to the regional and/or language settings.

36. The medium of claim 34 wherein capturing is performed by a computer having regional and/or language settings and wherein the rendering is in accordance with the regional and/or language settings.

37. The medium of claim 33 wherein only changes in non-timecode binary data are provided as textual data.

38. The medium of claim 32 wherein the providing comprising providing the captured DV metadata as DVD-Video sub-picture graphics.

39. The medium of claim 32 wherein capturing is performed by a computer having regional and/or language settings and wherein capturing includes reformatting the date and/or time information according to the regional and/or language settings.

40. The medium of claim 32 wherein capturing is performed by a computer having regional and/or language settings and wherein the rendering is in accordance with the regional and/or language settings.

41. The medium of claim 32 wherein the instructions further comprise permitting a user to select the DVD-Video sub-picture stream in which the DV metadata is stored.

42. A DVD recordable computer readable medium having stored thereon a data structure corresponding to DV digital video metadata of DV data including DV video frames and audio samples, said data structure comprising DVD-Video data including:
DVD-Video frames corresponding to the DV video frames and audio samples; and
DVD-Video stream data corresponding to the DV metadata in a DVD-Video stream.

43. The method of claim 42 wherein the DVD-Video stream data comprises a set of DVD-Video sub-picture graphics.

44. The method of claim 42 wherein only changes in non-timecode binary data are stored as textual data in the DVD-Video track.

45. A method of converting captured DV data including a video portion, an audio portion and a metadata portion into DVD-Video data, said method comprising:
converting the video portion and the audio portion of DV data into corresponding DVD-Video video data and DVD-Video audio data; and
converting parts of the metadata portion of DV data into DVD-Video sub-picture streams and DVD-Video Text Data (TXTDT).

46. The method of claim 45 further comprising:
streaming the DV data, from an acquisition device; and
capturing of the streaming DV data for real-time conversion of the captured DV data into DVD-Video data or for storage of the captured DV data on a computer mass storage device for subsequent conversion of the captured DV data into DVD-Video data.
